(19) United States
(12) Patent Application Publication
(10) Pub. No.: US 2020/0019218 A1
(43) Pub. Date: Jan. 16, 2020

(54) PIVOT STRUCTURE AND AN ELECTRONIC DEVICE HAVING THE PIVOT STRUCTURE

(71) Applicant: Acer Incorporated, New Taipei City (TW)

(72) Inventors: Chao-Di SHEN, New Taipei City (TW); Yan-Lin KUO, New Taipei City (TW)

(21) Appl. No.: 16/143,807

(22) Filed: Sep. 27, 2018

(30) Foreign Application Priority Data
Jul. 10, 2018 (TW) 107123877

(51) Int. Cl. G06F 1/16; E05D 3/12

(52) U.S. Cl. CPC G06F 1/1681; G06F 1/1616; H04M 1/022; E05D 3/122; G06F 1/1679

(57) ABSTRACT

A pivot structure includes a first driven device, a middle driven device, a second driven device, a driving axis, a first restriction device, a middle restriction device, and a second restriction device. The first restriction device includes a first circumferential portion and a second circumferential portion, the middle restriction device includes a first recess and an abutting portion, and the second restriction device includes a second recess and an outer edge portion. When the first circumferential portion of the first restriction device abuts the first recess of the middle restriction device, the abutting portion of the middle restriction device abuts the outer edge portion of the second restriction device. When the second circumferential portion of the first restriction device abuts the first recess of the middle restriction device, the abutting portion of the middle restriction device abuts the second recess of the second restriction device.

### CROSS-REFERENCE TO RELATED APPLICATIONS

The present application claims priority to Taiwan Patent Application No. 107123877 filed on Jul. 10, 2018, the entirety of which are incorporated by reference herein.

### BACKGROUND OF THE INVENTION

### Field of the Invention

The invention relates to a pivot structure and an electronic device having the pivot structure, and more particularly to a pivot structure used in a folding-type electronic device.

### Description of the Related Art

More and more consumers are demanding that their electronic devices (e.g. notebooks and cellphones) be lightweight and miniaturized, which results in most of such electronic products having thinner bodies. However, this kind of thin mechanism may sacrifice space that would otherwise be useful in heat dissipation, resulting in adverse effects on temperature reduction in the electronic devices.

### BRIEF SUMMARY OF THE INVENTION

A pivot structure is provided in an embodiment of the present invention, including a first transmission device, a middle transmission device, a second transmission device, a drive shaft, a first restriction device, a middle restriction device, and a second restriction device. The middle transmission device is meshed with the first transmission device. The second transmission device is meshed with the middle transmission device. The drive shaft passes through the first transmission device. The first restriction device is disposed on the drive shaft and includes first circumferential portion and a second circumferential portion. The middle restriction device includes a first recess and an abutting portion, wherein the first recess faces the first restriction device, and the abutting portion is at the opposite side of the first recess. The second restriction device abuts the middle restriction device and includes a second recess and an outer edge portion. When the first circumferential portion of the first restriction device abuts the first recess of the middle restriction device, the abutting portion of the middle restriction device abuts the outer edge portion of the second restriction device. When the second circumferential portion of the first restriction device abuts the first recess of the middle restriction device, the abutting portion of the middle restriction device abuts the second recess of the second restriction device.

A pivot structure is provided in another embodiment of the present invention, including a first transmission device, a middle transmission device, a second transmission device, and a driven shaft. The middle transmission device is meshed with the first transmission device. The second transmission device is detachably connected to the middle transmission device. The driven shaft passes through the second transmission device and is rotated by the rotation of the second transmission device, wherein the middle transmission device includes a column, and the second transmission device includes a recess. The column is disposed in the recess and the second transmission device is rotated by the rotation of the middle transmission device when the distance between the center of the column and the center of the driven shaft is less than the first distance.

An electronic device is provided in a further embodiment of the present invention, including a lower case, a pivot structure, and an upper case. The pivot structure connects with the lower case and the upper case to allow the upper case rotate with respect to the lower case between a maximum angle and a minimum angle.

### BRIEF DESCRIPTION OF THE DRAWINGS

The invention can be more fully understood by reading the subsequent detailed description and examples with references made to the accompanying drawings, wherein:

FIG. 1A is an electronic device illustrated according to an embodiment of the present invention.

FIG. 1B is a partially enlarged view of FIG. 1A.

FIG. 2A is a perspective view of a pivot structure in FIG. 1A.

FIG. 2B is an exploded view of the pivot structure in FIG. 2A.

FIGS. 3A-3B are schematic views of some elements of the pivot structure in FIG. 2A.

FIG. 4A is a perspective view of the pivot structure in FIG. 2A under one condition.

FIGS. 4B-4C are schematic views of some elements of the pivot structure in FIG. 4A.

FIG. 5A is a perspective view of the pivot structure in FIG. 2A under another condition.

FIGS. 5B-5C are schematic views of some elements of the pivot structure in FIG. 5A.

FIG. 6A is a perspective view of the pivot structure in FIG. 2A under another condition.

FIGS. 6B-6D are schematic views of some elements of the pivot structure in FIG. 6A.

FIG. 7A is a perspective view of the pivot structure in FIG. 2A under another condition.

FIGS. 7B-7C are schematic views of some elements of the pivot structure in FIG. 7A.

FIGS. 8A and 8B are a perspective and an exploded view of a pivot structure in another embodiment of the present invention, respectively.

FIG. 8C is a schematic view of some elements of the pivot structure in FIG. 8A.

FIG. 9A is a perspective view of the pivot structure in FIG. 8A under another condition.

FIG. 9B is a schematic view of some elements of the pivot structure in FIG. 9A.

FIG. 10A is a perspective view of the pivot structure in FIG. 8A under another condition.

FIG. 10B is a schematic view of some elements of the pivot structure in FIG. 10A.

FIG. 11A is a perspective view of the pivot structure in FIG. 8A under another condition.

FIG. 11B is a schematic view of some elements of the pivot structure in FIG. 11A.

FIG. 12A is a perspective view of the pivot structure in FIG. 8A under another condition.

FIG. 12B is a schematic view of some elements of the pivot structure in FIG. 12A.

FIG. 13A is a perspective view of a pivot structure in a further embodiment of the present invention.

FIG. 13B is a schematic view of some elements of the pivot structure in FIG. 13A.

### DETAILED DESCRIPTION OF THE INVENTION

A pivot structure is discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

The abovementioned and other technical contents, features and effects relating to the present invention are clearly shown in the description of a preferred embodiment with reference figures. The directional phrases, such as on, under, left, right, front or rear are the directions relative to the reference figures. As a result, the directional phrases are only for illustration and is not intended to restrict this invention.

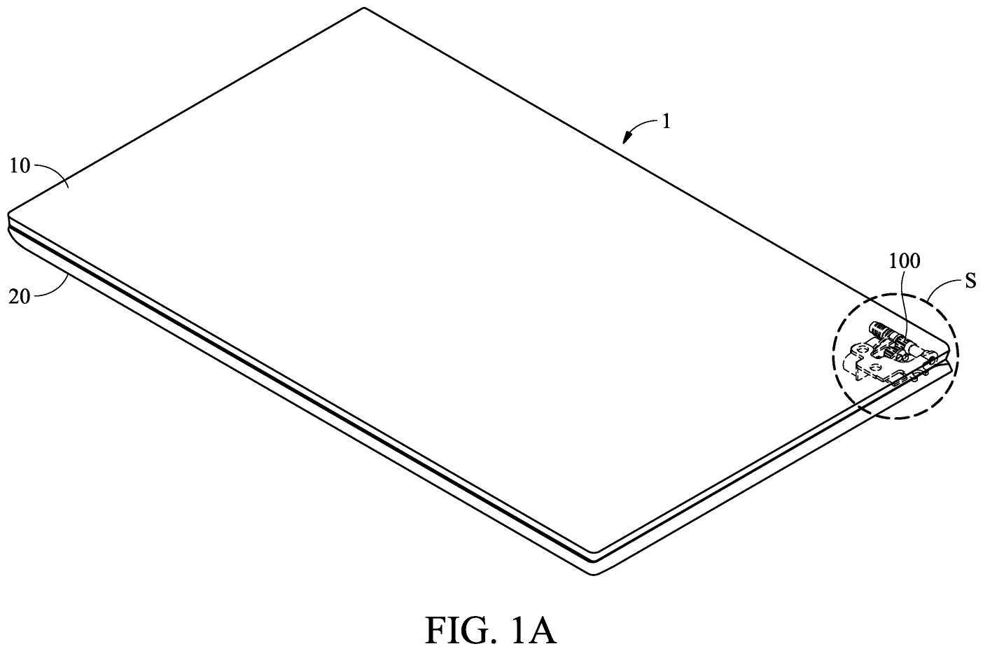

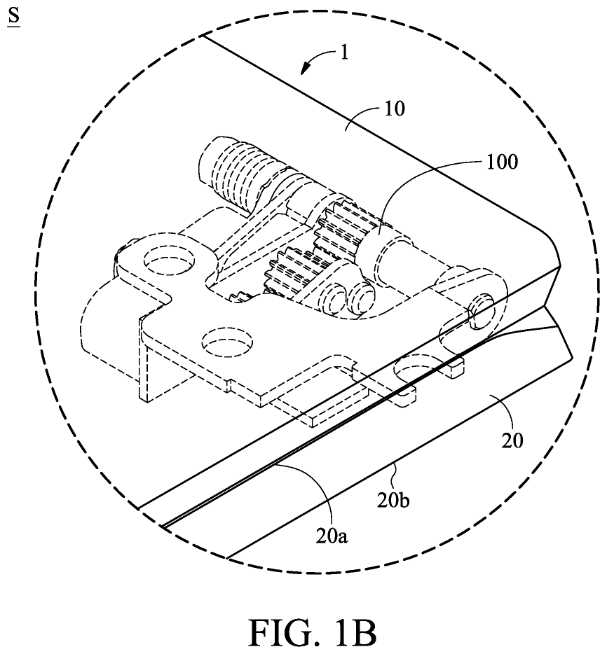

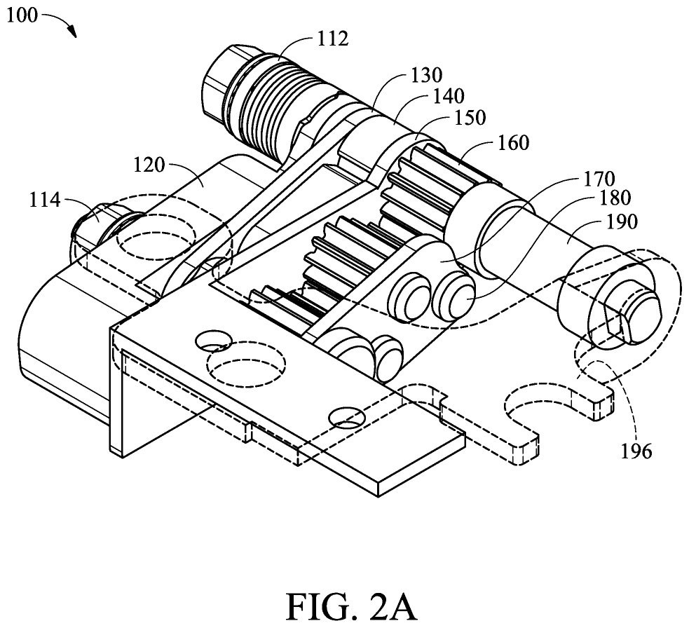

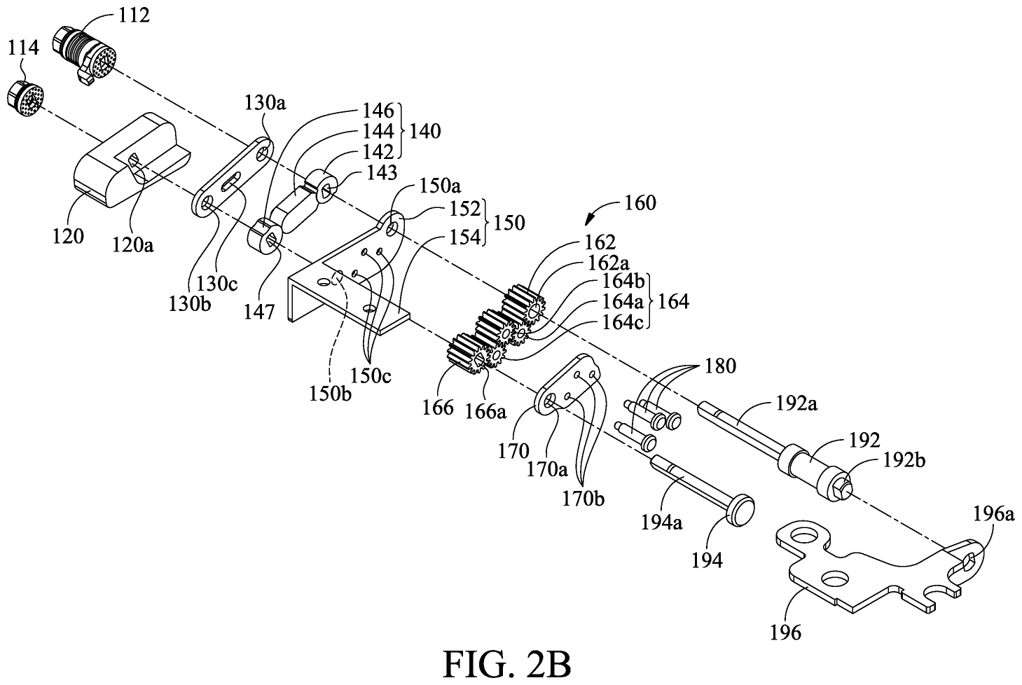

Referring to FIGS. 1A and 2B, an electronic device 1 is illustrated in FIG. 1A, including an upper case 10, a lower case 20, and a pivot structure 100, wherein the electronic device 1 is a folding-type electronic device, such as a notebook or a cellphone. The pivot structure 100 is disposed in the upper case 10 and the lower case 20, and the upper case 10 may be opened or closed relative to the lower case 20 by the pivot structure 100. FIG. 1B is an enlarged view of a region S in FIG. 1A, wherein the lower case 20 has an upper cover 20a facing the upper case 10 and a lower cover 20b opposite to the upper cover 20a. The upper cover 20a and/or the lower cover 20b are not fully fixed. Instead, they can be opened and closed upwardly or downwardly relative to the lower case 20 (which will be described in detail later). Although only one pivot structure 100 is illustrated in FIG. 1A, it is only for illustration and the present invention is not limited thereto. For example, another pivot structure which is symmetrical to the pivot structure 100 may be disposed at the opposite side of the electronic device 1, depending on design requirements.

Referring to FIGS. 2A and 2B, wherein FIG. 2A is a perspective view of the pivot structure 100, and FIG. 2B is an exploded view of the pivot structure 100. The pivot structure 100 includes a locking device 112, a locking device 114, a lifting mechanism 120, a first bracket 130, a restriction mechanism 140, a second bracket 150, a transmission mechanism 160, a third bracket 170, a plurality of fixing devices 180, a drive shaft 192, a driven shaft 194, and a connecting board 196. The restriction mechanism 140 includes a first restriction device 142, a middle restriction device 144, and a second restriction device 146. The second bracket 150 includes a body 152 perpendicular to the drive shaft 192, and a protruding portion 154 extending parallel to the drive shaft 192. The transmission mechanism 160 includes a first transmission device 162, a middle transmission device 164, and a second transmission device 166 which are meshed sequentially to each other. The middle transmission device 164 includes three transmission gears 164a, 164b, and 164c.

In FIG. 2B, the drive shaft 192 passes through a round hole 162a of the first transmission device 162, a hole 150a of the second bracket 150, a hole 143 of the first restriction device 142, a hole 130a of the first bracket 130 from right to left, and then is fixed by the locking device 112. A hole 196a of the connecting board 196 is disposed on a protruding portion 192b of the drive shaft 192. The driven shaft 194 passes through a hole 170a of the third bracket 170, a non-rounded hole 166a of the second transmission device 166, a hole 150b of the second bracket 150, a hole 147 of the second restriction device 146, a hole 130b of the first bracket 130, a hole 120a of the lifting mechanism 120 from right to left, and then is fixed by the locking device 114. Three fixing devices 180 pass through the holes 170b of the third bracket 170, the transmission gears 164a, 164b, 164c, and a hole 150c of the second bracket 150 from right to left.

The locking devices 112 and 114 are, for example, a combination of nuts, bolts, and gaskets for fixing the position of other components of the pivot structure 100 in the direction of the drive shaft 192 and the driven shaft 194. The first transmission device 162, the middle transmission device 164, and the second transmission device 166 may be devices that are able to transmit torque, such as gears.

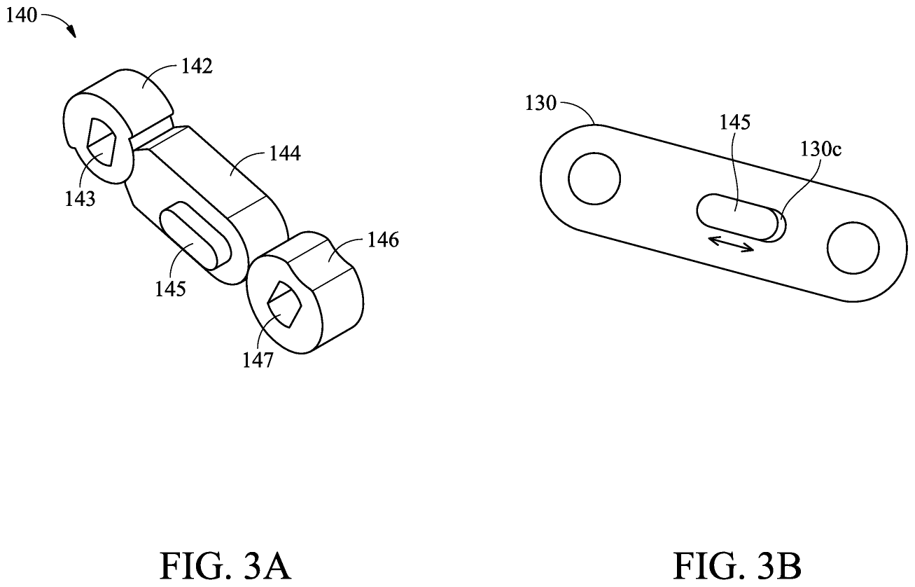

Referring to FIGS. 2B, 3A and 3B, wherein FIG. 3A illustrates the details of the restriction mechanism 140, FIG. 3B illustrates the first bracket 130 assembled with the restriction mechanism 140. The middle restriction device 144 includes a protruding portion 145. The protruding portion 145 is movably disposed in the hole 130c of the first bracket 130 (as shown by the arrow in FIG. 3B) when the pivot structure 100 is being assembling.

In this embodiment, the connecting board 196 is embedded in the upper case 10 of the electronic device 1, and the protruding portion 154 of the second bracket 160 is embedded in the lower case 20 (FIG. 1A). As a result, when the upper case 10 is opened or closed relative to the lower case 20, the connecting board 196 may be driven by the upper case 10 to rotate, thereby providing torque to the drive shaft 192 to drive the drive shaft 192. At the same time, the first restriction device 142 and the first transmission device 162 may be rotated by the rotation of the drive shaft 192. Afterwards, the first transmission device 162 drives the middle transmission device 164, thereby driving the second transmission device 166. Therefore, the driven shaft 194, the lifting mechanism 120 disposed on the driven shaft 194, and the second restriction device 146 are rotated by the second transmission device 166.

Although three transmission gears 164a, 164b, and 164c are illustrated in the middle transmission device 164 of the present embodiment, the present invention is not limited thereto. For example, the number of transmission gears may be increased or decreased, and the relative positions of the transmission gears may also be adjusted, depending on design requirements. It is also possible for the first transmission device 162 to mesh directly with the second transmission device 166 to transmit torque without using any middle transmission device.

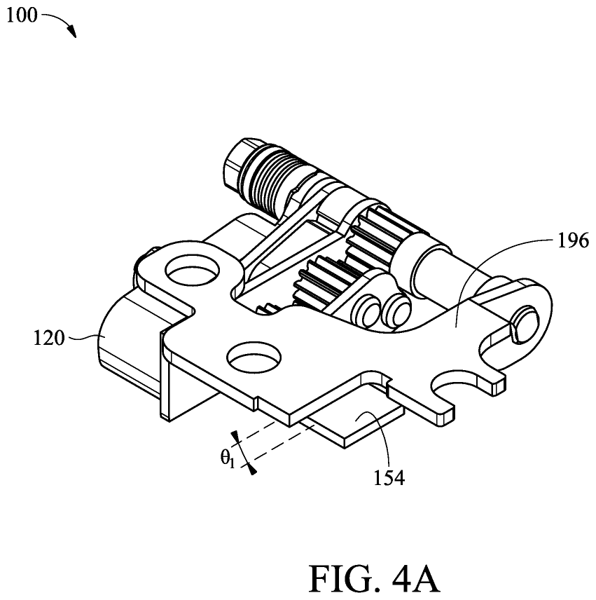

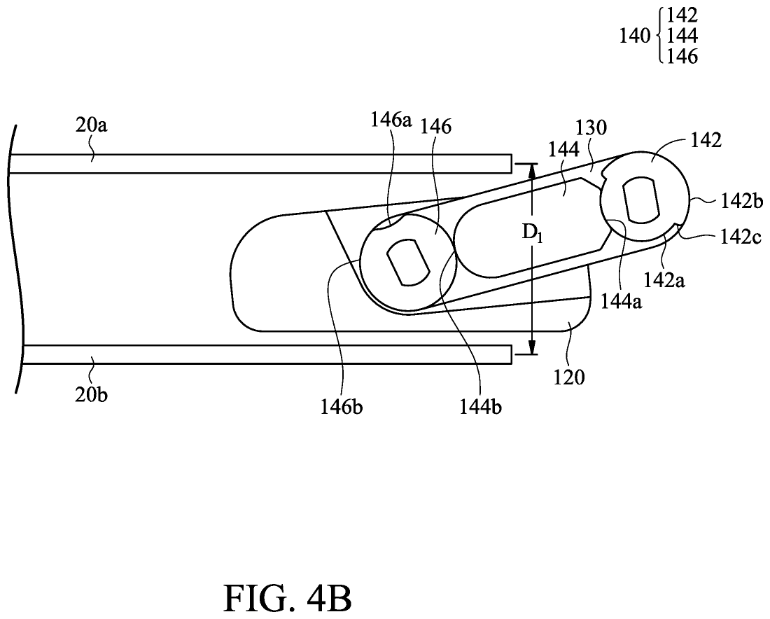

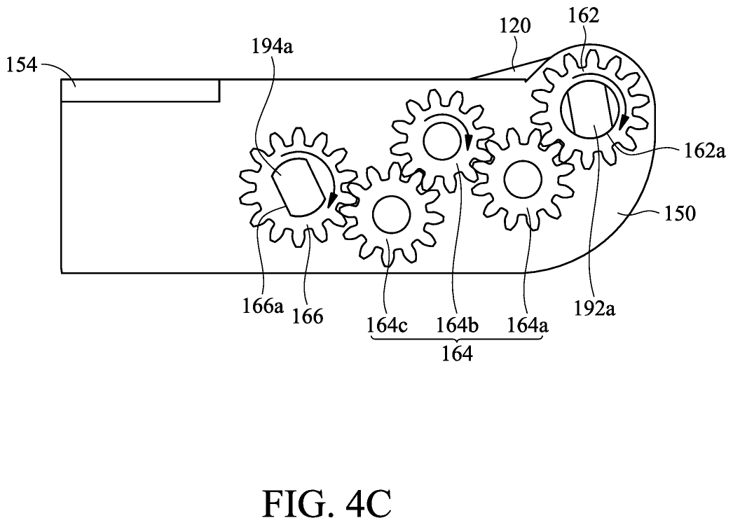

Referring to FIGS. 4A-4C, FIG. 4A illustrates a perspective view of the pivot structure 100 of the present invention, FIG. 4B is a schematic view of the relative relationship between some components of the pivot structure 100 and the upper cover 20a and the lower cover 20b, and FIG. 4C is a schematic view of some components of the pivot structure 100 in FIG. 4A.

The upper case 10 and the lower case 20 of the electronic device 1 (FIG. 1A) are closed at this time. As a result, the angle θ1 (the lowest angle) between the connecting plate 196 embedded in the upper case 10 and the protruding portion 154 embedded in the lower case 20 is about 0 degrees. The angle θ1 is approximately the same as the angle between the upper case 10 and the lower case 20. In FIG. 4B, the first restriction device 142 includes a first circumferential portion 142a, a second circumferential portion 142b, and a junction 142c connecting the first circumferential portion 142a and the second circumferential portion 142b, wherein the radius of the first circumferential portion 142a is smaller than that of the second circumferential portion 142b. The middle restriction device 144 includes a first recess 144a facing the first restriction device 142, and an abutting portion 144b opposite to the first recess 144a. The second restriction device 146 includes a second recess 146a and an outer edge portion 146b.

Meanwhile, when the angle θ1 between the connecting board 196 and the protruding portion 154 is about 0 degrees, the first circumferential portion 142a abuts the first recess 144a, and the abutting portion 144b abuts the outer edge portion 146b. Furthermore, the lifting mechanism 120 does not contact the upper cover 20a or the lower cover 20b. Instead, the lifting mechanism 120 is substantially horizontally disposed between the upper cover 20a and the lower cover 20b (as shown in FIG. 4B). As a result, the upper cover 20a and the lower cover 20b do not move relative to each other, and a maximum vertical distance between them is distance D1.

In FIG. 4C, a non-rounded portion 192a of the drive shaft 192 is disposed in the round hole 162a of the first transmission device 162, and a non-rounded portion 194a of the driven shaft 194 is disposed in the non-rounded hole 166a of the second transmission device 166. It should be noted that the non-rounded portion 192a of the drive shaft 192 does not have the same shape as the round hole 162a of the first transmission device 162, so the non-rounded portion 192a and the round hole 162a are not totally fitted. However, the non-rounded portion 194a of the driven shaft 194 has a substantially identical shape as the non-rounded hole 166a of the second transmission device 166. Although the non-rounded portion 192a of the drive shaft 192 is not totally fitted with the rounded hole 162a of the first transmission device 162, there is friction between the contact of the non-rounded portion 192a and the round hole 162a, so the first transmission device 162 may rotate through the rotation of the drive shaft 192 rather than moving relative to the drive shaft 192 when the drive shaft 192 starts to rotate (as shown by the arrow in FIG. 4C). As a result, the middle transmission device 164 (which includes the transmission gears 164a, 164b, 164c) and the second transmission device 166 are driven, which also drives the driven shaft 194 and lifting mechanism 120 disposed on the driven shaft 194.

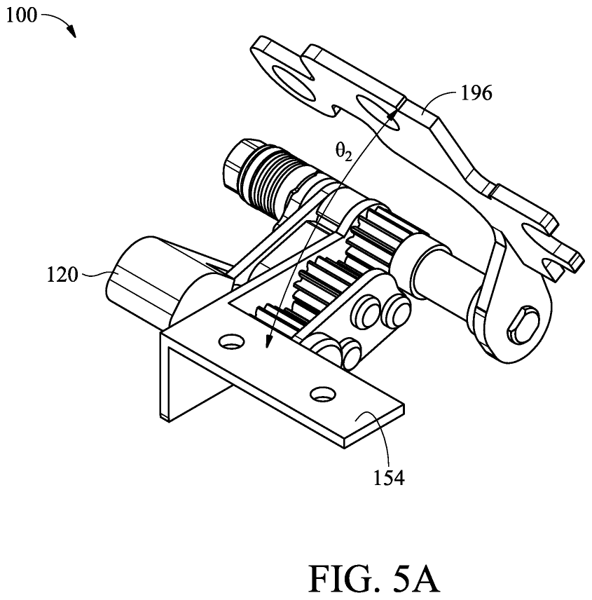

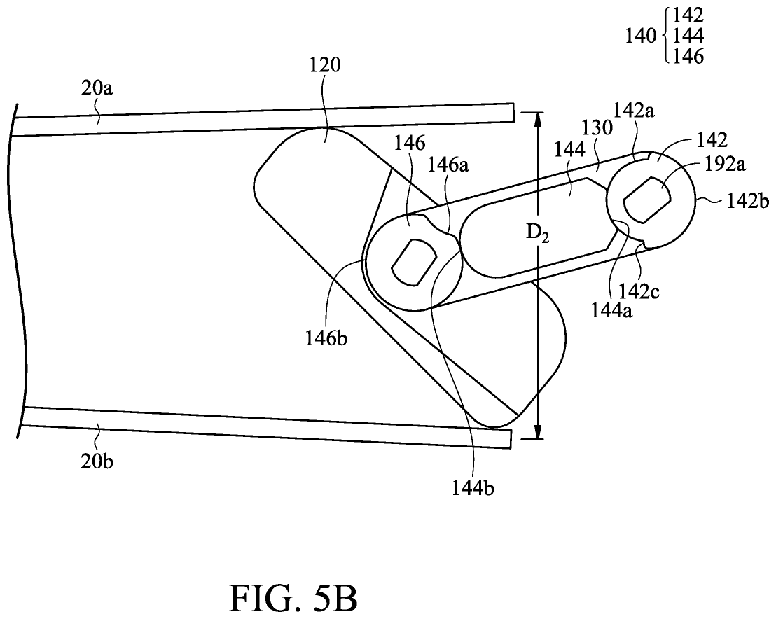

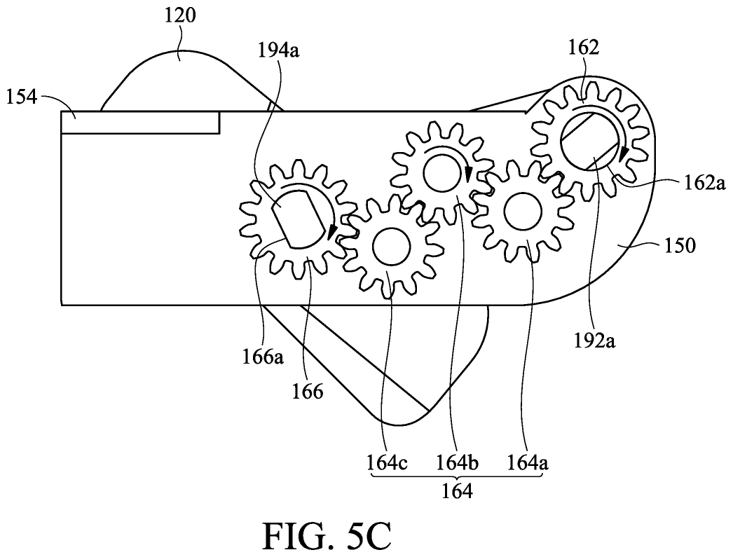

Referring to FIGS. 5A-5C. FIG. 5A is a perspective view of the pivot structure 100 under another condition, FIG. 5B is a schematic view of some components of the pivot structure 100 in FIG. 5A, the upper cover 20a, and the lower cover 20b, and FIG. 5C is a schematic view of some components of the pivot structure 100.

Meanwhile, compared to what is illustrated in FIGS. 4A-4C, the connecting board 196 shown in FIG. 5A is rotated further clockwise relative to the protruding portion 154 (FIG. 5A), so the angle θ2 between the connecting board 196 and the protruding portion 154 is greater than the angle θ1 between the connecting board 196 and the protruding portion 154 in FIGS. 4A-4C, as shown in FIG. 5A. Under this condition, the angle θ2 is approximately the same as the angle between the upper case 10 and the lower case 20.

In FIG. 5B, when the drive shaft 192 is driven by the connecting board 196 to rotate clockwise, the first restriction device 142 still abuts the first recess 144a of the middle restriction device 144 by first circumferential portion 142a, the junction 142c does not contact the middle restriction device 144, and the middle restriction device 144 still abuts the outer edge portion 146b of the second restriction device 146 by the abutting portion 144b. It should be noted that the second recess 146a of the second restriction device 146 is closer to the abutting portion 144b of the middle restriction device 144 compared to FIG. 4B. Furthermore, the lifting mechanism 120 is also driven to rotate to abut the upper cover 20a and the lower cover 20b to increase the maximum vertical distance between the upper cover 20a and the lower cover 20b from distance D1 in the previous condition to distance D2. Although the lifting mechanism 120 is illustrated as contacting the upper cover 20a and the lower cover 20b at the same time under this condition, the present invention is not limited thereto. For example, the position and/or shape of the lifting mechanism 120 or other mechanisms may be altered to make the lifting mechanism 120 only comes into contact with either the upper cover 20a or the lower cover 20b. With this configuration, the upper cover 20a and/or lower cover 20b of the lower case 20 may be opened when opening the upper case 10 of the electronic device 1. As a result, the space for air to come in or for heat dissipation is increased to increase the heat dissipation effect of the electronic device 1.

Compared to FIG. 4C, the non-rounded portion 192a of the drive shaft 192 in FIG. 5C is rotated clockwise, and the first transmission device 162 is still driven by the friction between the non-rounded portion 192a of the drive shaft 192 and the rounded hole 162a of the first transmission device 162, and therefore the middle transmission device 164, the second transmission device 166, the driven shaft 194 and the lifting mechanism 120 are driven together.

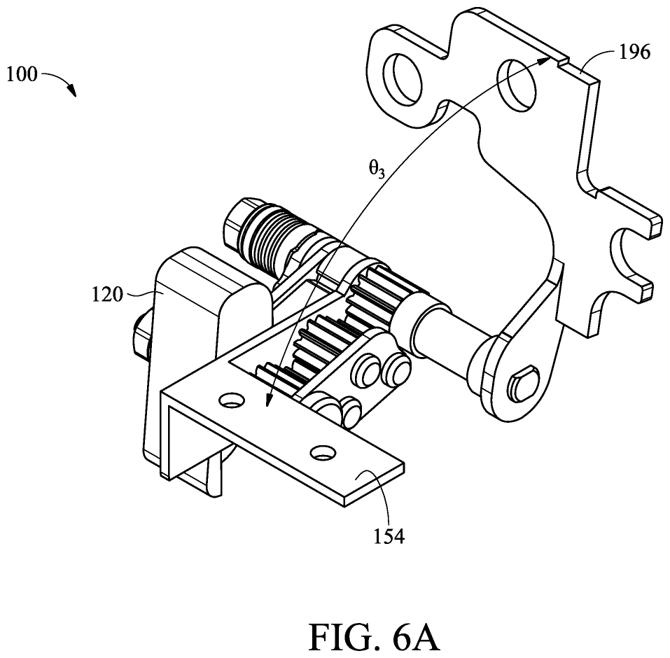

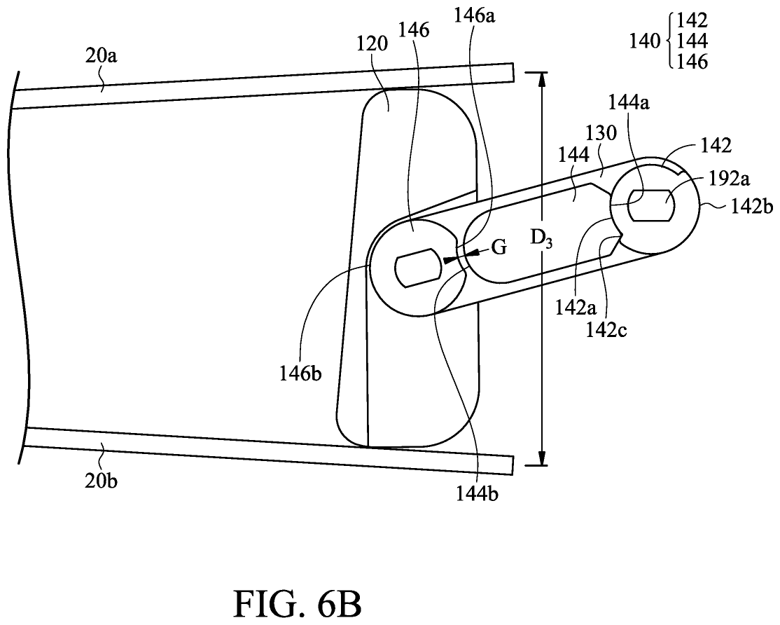

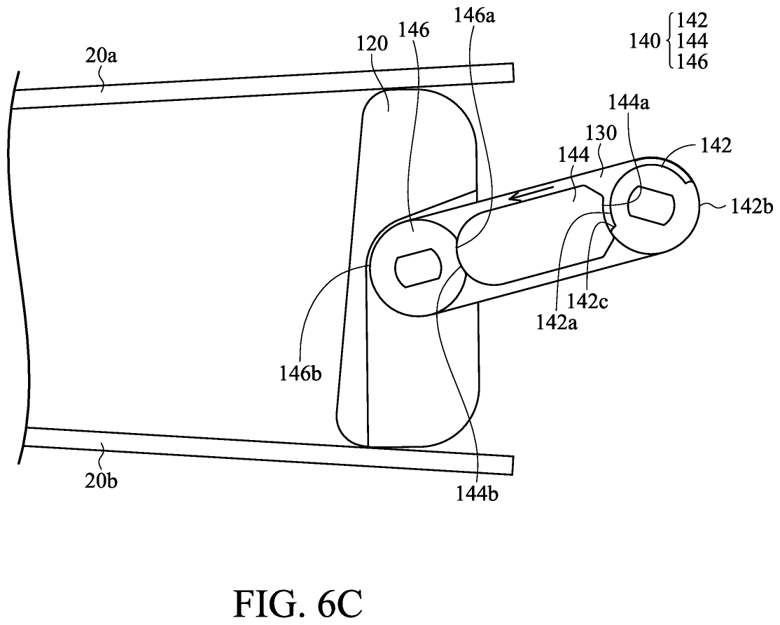

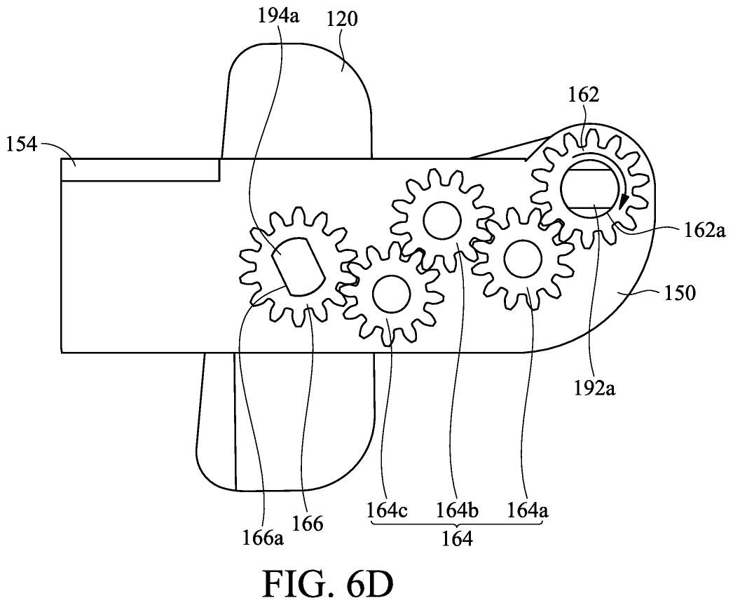

Referring to FIGS. 6A-6D. FIG. 6A is a peripheral view of the pivot structure 100 under another condition, FIGS. 6B and 6C are schematic views of some components of the pivot structure 100 and the upper cover 20a and the lower cover 20b, and FIG. 6D is a schematic view of some components of the pivot structure 100.

Comparing to the conditions illustrated in FIGS. 5A-5C, in FIG. 6A, the connecting board 196 is rotated further clockwise relative to the protruding portion 154 under the condition illustrated in FIGS. 6A-6D. As a result, as shown in FIG. 6A, an angle θ3 (the threshold angle) between the connecting board 196 and the protruding portion 154 is greater than the angle θ2 between the connecting board 196 and the protruding portion 154 in FIGS. 5A-5C. The angle θ3 is approximately the same as the angle between the upper case 10 and the lower case 20. Meanwhile, the angle θ3 is an angle at which a common user would use with this kind of folding-type electronic device, which is about 100 degrees, or between about 90 degrees and about 110 degrees.

In FIG. 6B, while the connecting board 196 keeps driving the drive shaft 192 to rotate, the first restriction device 142 continues to abut the first recess 144a of the middle restriction device 144 by the first circumferential portion 142a, but the junction 142a abuts the middle restriction device 144 at this time. It should be noted that the abutting portion 144b of the middle restriction device 144 is facing the second recess 146a of the second restriction device 146. As a result, a gap G is formed between the abutting portion 144b of the middle restriction device 144 and the second recess 146a of the second restriction device 146.

Meanwhile, the lifting mechanism 120 is rotated further compared to condition in FIG. 5B, so the maximum vertical distance between the upper cover 20a and the lower cover 20b is increased from distance D2 to distance D3. As a result, the space for air to come in or for heat dissipation is increased further to increase the heat dissipation effect of the electronic device 1.

FIG. 6C is a schematic view after the first restriction device 142 in FIG. 6B slightly rotates clockwise. At this time, the angle (not shown) between the connecting board 196 and the protruding portion 154 is approximately equal to the angle θ3 (the threshold angle) between the connecting board 196 and the protruding portion 154 in FIG. 6B, and the first restriction device 142 contacts the first recess 144a of the middle restriction device 144 by the second circumferential portion 142b having a larger radius rather than the first circumferential portion 142a. Furthermore, the middle restriction device is movably disposed (as shown in FIG. 3B), the middle restriction device 144 may be pushed by the second circumferential portion 142b of the first restriction device 142 (as shown by the arrow in FIG. 6C). As a result, the abutting portion 144b of the middle restriction device 144 may abut and fix in the second recess 146a of the second restriction device 146 to prevent the second restriction device 146 from rotating.

FIG. 6D is a schematic view of other components of the pivot structure 100 in FIG. 6C. Meanwhile, the rotation of the second restriction device 146 is limited by the middle restriction device 144 (FIG. 6C), so the rotation of the driven shaft 194 is also limited. In other words, the second transmission device 166, the middle transmission device 164 meshed with the second transmission device 166, the first transmission device 164 and the lifting mechanism 120 disposed on the driven shaft 194 cannot rotate further. It should be noted that the drive shaft 192 is in partial contact with the rounded hole 162a of the first transmission device 162 via the non-rounded portion 192a, rather than being totally affixed to each other, so the non-rounded portion 192a of the drive shaft 192 may keep rotating (as shown by the arrow in FIG. 6D) if the force applied thereto is great enough to overcome the maximum static friction between the non-rounded portion 192a and the rounded hole 162a of the first transmission device 162, and the first transmission device 162 remains static. Because the lifting mechanism 120 cannot be rotated, the distance between the upper cover 20a and the lower cover 20b is still D3, the same as in FIG. 6B. In other words, the upper case 10 of the electronic device 1 may keep opening relative to the lower case 20 while the distance between the upper cover 20a and the lower cover 20b is not increased. As a result, when the angle between the upper case 10 and the lower case 20 is about angle θ3 (a common angle for the use of this kind of folding-type electronic device), the distance between the upper cover 20a and the lower cover 20b may reach the maximum, and the user may receive the best heat dissipation effect for the electronic device when used under the best condition.

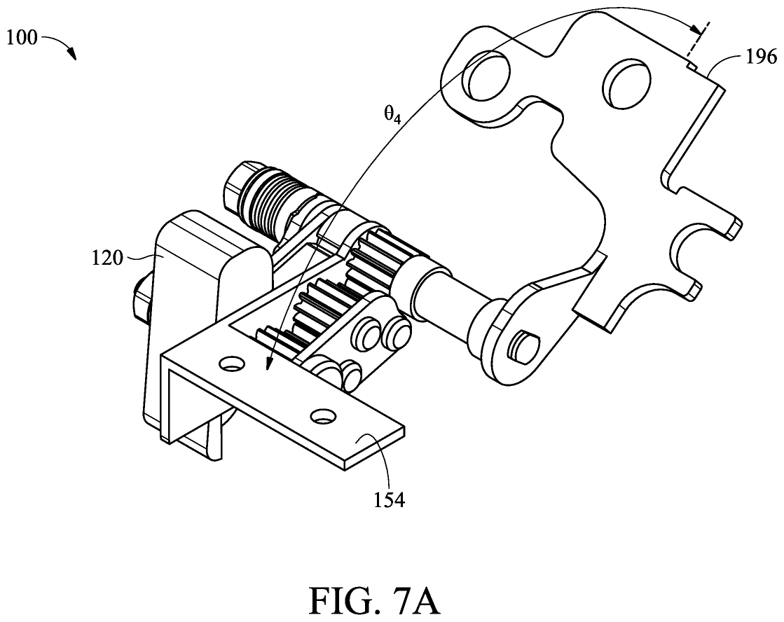

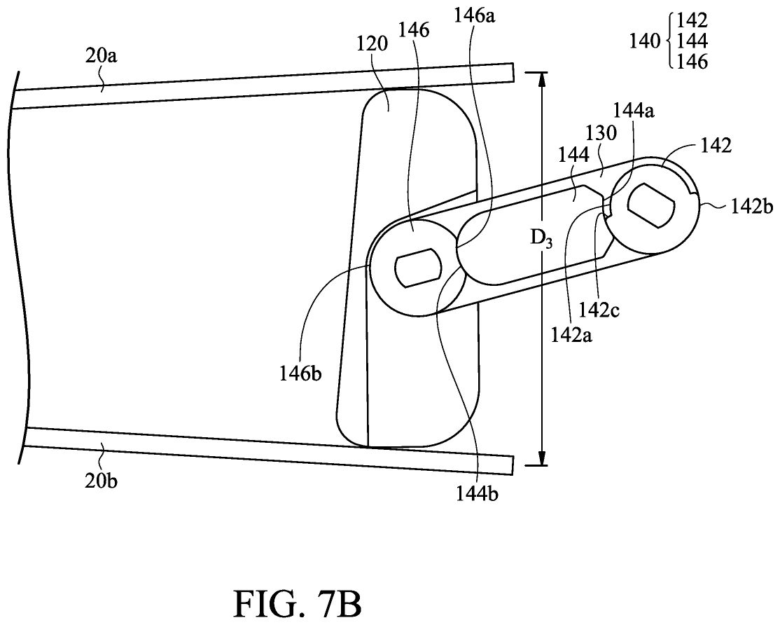

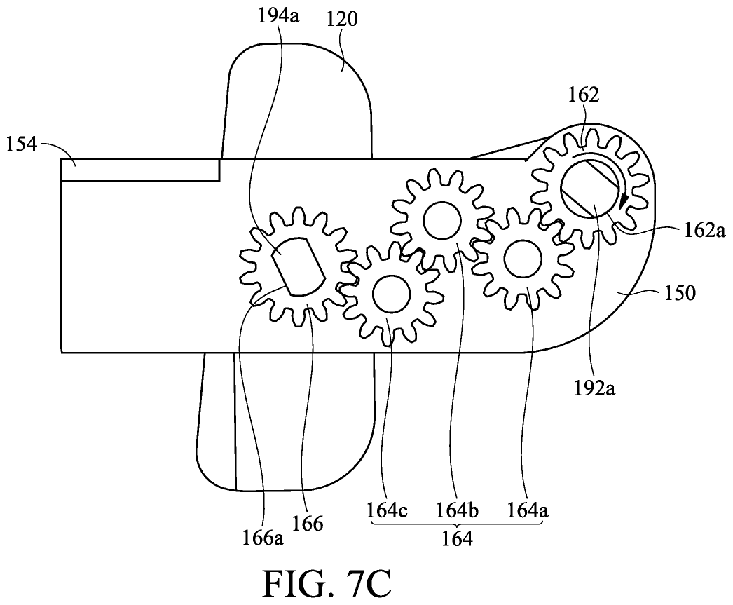

Referring to FIGS. 7A-7C. FIG. 7A is a perspective view of the pivot structure 100 under another condition, FIG. 7B is a schematic view of some components of the pivot structure 100 and the upper cover 20a and the lower cover 20b, and FIG. 7C is a schematic view of some components of the pivot structure 100.

At this time, compared to the condition in FIGS. 6A-6D, as shown in FIG. 7A, the connecting board 196 is rotated further clockwise relative to the protruding portion 154 to allow an angle θ4 (maximum angle) between the connecting board 196 and the protruding portion 154 to be greater than the angle θ3 between the connecting board 196 and the protruding portion 154 in FIG. 6A-6D. The angle θ4 is approximately the same as the angle between the upper case 10 and the lower case 20 under this condition. The upper case 10 of the electronic device 1 is opened to the largest degree relative to the lower case 20 after the angle between the protruding portion 154 and the connecting board 196 reaches the angle θ4, which is about 140 degrees (such as 130-150 degrees).

Referring to FIG. 7B, the first restriction device 142 still abuts the first recess 144a of the middle restriction device 144 by the second circumferential portion 142b, as shown in FIG. 6C. Compared to the aforementioned conditions, the middle restriction device 144 is abutted and fixed to the outer edge portion 146b of the second restriction device 146 by the abutting portion 144b, which limits the rotation of the second restriction device 146, so the rotation of the driven shaft 194 and of the lifting mechanism 120 disposed on the driven shaft 194 is also limited. As a result, the distance between the upper cover 20a and the lower cover 20b is still distance D3 and is not increased.

When FIG. 7C is compared to FIG. 6D, only the non-rounded portion 192a of the drive shaft 192 is rotated clockwise relative to the rounded hole 162a of the first transmission device 162 (as shown by the arrow in FIG. 7C). As a result, the distance between the upper cover 20a and the lower cover 20b is not increased by the lifting mechanism 120 when the upper case 10 brings the connecting board 196 to rotate further, as described above. Therefore, the angle between the upper case 10 and the lower case 20 only has to be an angle which is most suitable for a common user (e.g. angle θ3) to reach the best heat dissipation effect for the electronic device 1, instead of being the maximum angle between the upper case 10 and the lower case 20.

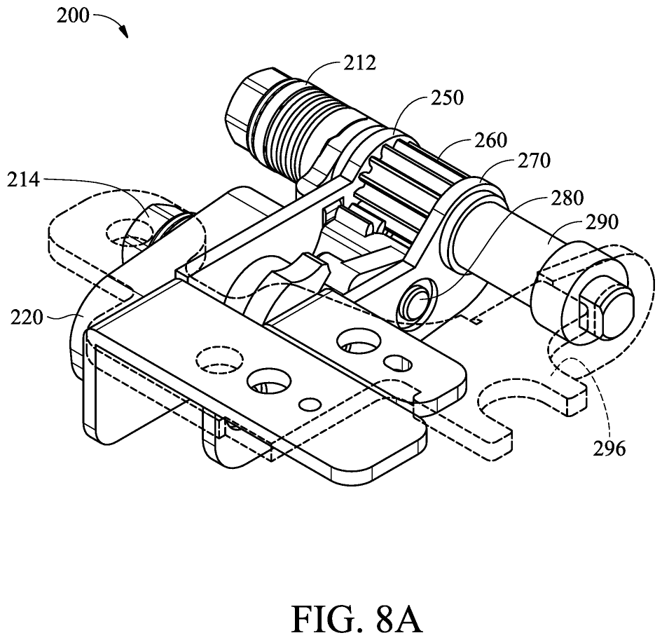

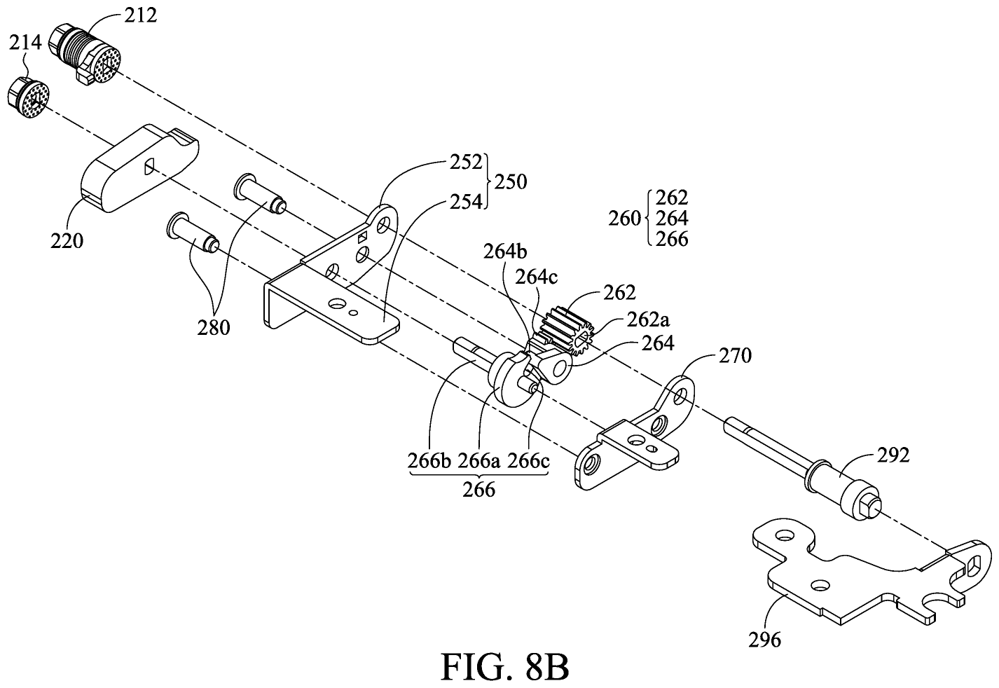

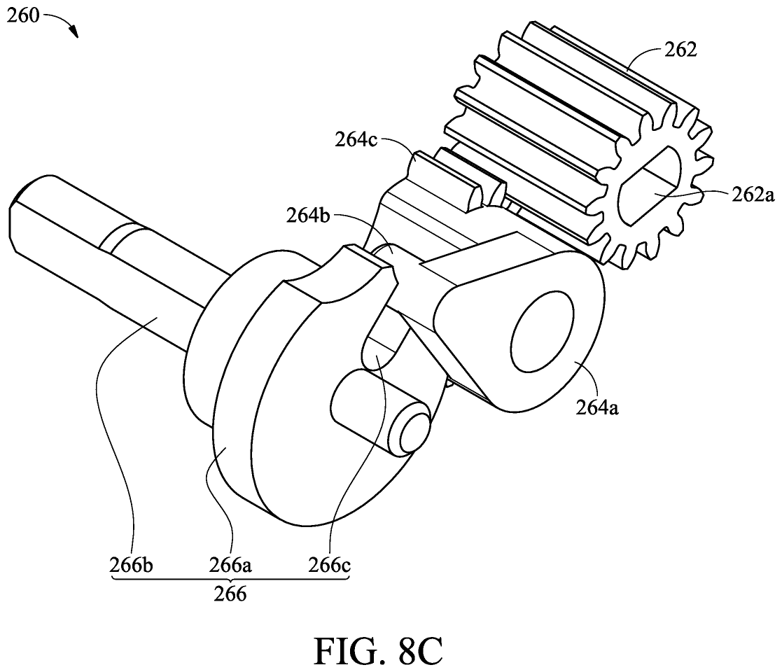

FIGS. 8A and 8B are a perspective view and an exploded view of a pivot structure 200 of another embodiment of the present invention, respectively. The pivot structure 200 is disposed in the electronic device 1 in a similar manner as the pivot structure 100, and the pivot structure 200 includes a locking device 212, a locking device 214, a lifting mechanism 220, a bracket 250, a transmission mechanism 260, a bracket 270, a plurality of fixing devices 280, a drive shaft 292, and a connecting board 296. The bracket 250 includes a body 252 perpendicular to the drive shaft 292, and a protruding portion 254 extending parallel to the drive shaft 292. The transmission mechanism 260 includes a first transmission device 262, a middle transmission device 264 and a second transmission device 266 which are connected to each other but separable. The pivot structure 200 is disposed in a position that is identical or similar to where the pivot structure 100 is disposed in the electronic device 1, and the connecting ways and the functions of the locking device 212, the locking device 214, the lifting mechanism 220, the bracket 250, the bracket 270, the plurality of fixing devices 280, the drive shaft 292, and the connecting board 296 are substantially similar to or the same as the locking device 112, the locking device 114, the lifting mechanism 120, the second bracket 150, the third bracket 170, the plurality of fixing devices 180, the drive shaft 192, and the connecting board 196, respectively, and the descriptions thereof not repeated herein.

Referring to FIG. 8C, which is an enlarged view of the transmission mechanism 260 in FIG. 8B. The first transmission device 262 has a hole 262a for the drive shaft 292 to pass through, which therefore allows the first transmission device 262 to rotate due to the rotation of the drive shaft 292. The middle transmission device 264 includes a wheel portion 264a, a column 264b extending in a direction that is parallel to the drive shaft 292, and a gear portion 264c meshed with the first transmission device 262. The second transmission device 266 includes a wheel portion 266a, a shaft portion 266b (driven shaft) positioned in the center of the wheel portion 266a and extending in a direction parallel to the drive shaft 292, and a recess 266c. Under some conditions, the column 264b of the middle transmission device 264 may be disposed in the recess 266c and move in a radius direction of the wheel portion 266a of the second transmission device 266 in the recess 266c. Although the wheel portion 266a and the shaft portion 266b are illustrated as one piece, the present invention is not limited thereto. For example, a similar effect may be achieved by a wheel portion and a drive shaft that are separate.

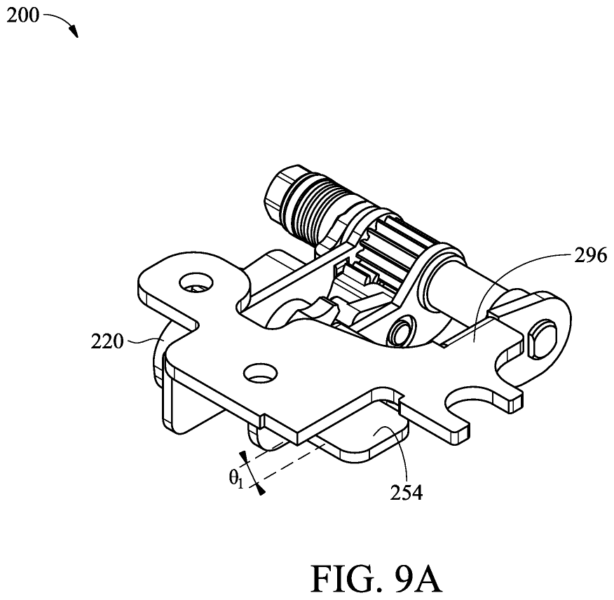

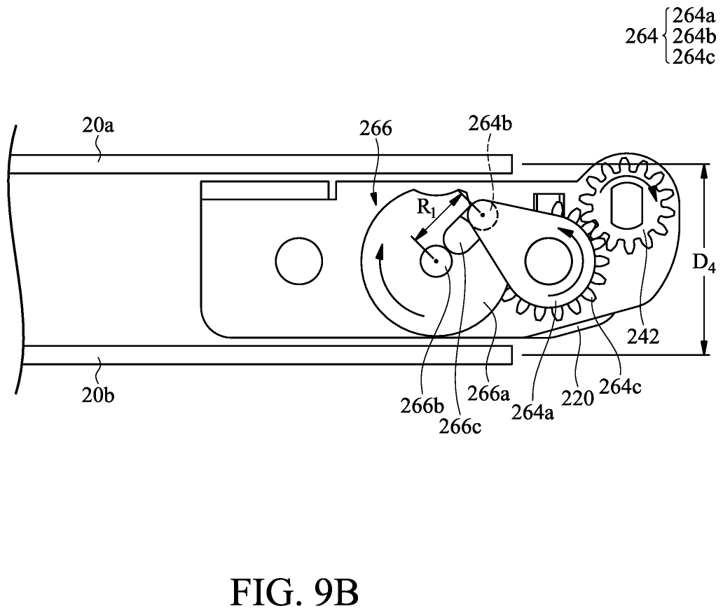

In FIG. 9A, the upper case 10 and the lower case 20 (not shown) of the electronic device 1 are closed. As a result, the angle θ1 between the connecting board 296 embedded in the upper case 10 and the protruding portion 254 embedded in the lower case 20 (minimum angle) is about 0 degrees. The angle θ1 is approximately the same as the angle between the upper case 10 and the lower case 20. FIG. 9B is a schematic view of some components of the pivot structure 200 in FIG. 9A. It is shown in FIG. 9B that when the angle θ1 is about 0 degrees (FIG. 9A), the column 264b of the middle transmission device 264 is substantially disposed at an opening of the recess 266c of the second transmission device 266, and the distance between the center of the column 264b and the center of the shaft portion 266b is R1 (first distance). The lifting mechanism 220 is disposed at one side of the bracket 250, and the first transmission device 262, the middle transmission device 264, and the second transmission device 266 are disposed at another side of the bracket 250.

Meanwhile, the lifting mechanism 220 does not contact the upper cover 20a or the lower cover 20b, but is disposed between the upper cover 20a and the lower cover 20b in a substantially horizontal manner. As a result, there is no movement between the upper cover 20a and the lower cover 20b, and the maximum vertical distance between the upper cover 20a and the lower cover 20b is distance D4.

Meanwhile, when the upper case 10 brings the connecting board 296 to rotate along with the drive shaft 292, the first transmission device 262 may be driven by the drive shaft 292, which then drives the middle transmission device 264 which is meshed with the first transmission device 262. At this time, the column 264b of the middle transmission device 264 may abut the recess 266c of the second transmission device 266 and apply a force to the recess 266c, thereby driving the second transmission device 266 to rotate clockwise (as shown by the arrow of FIG. 9B).

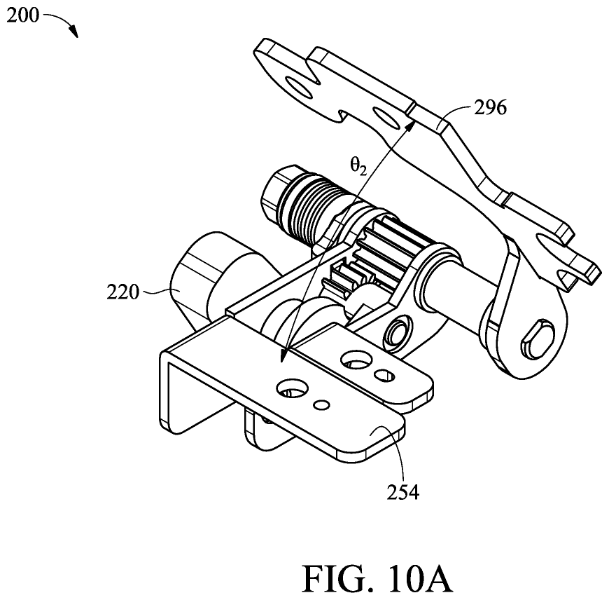

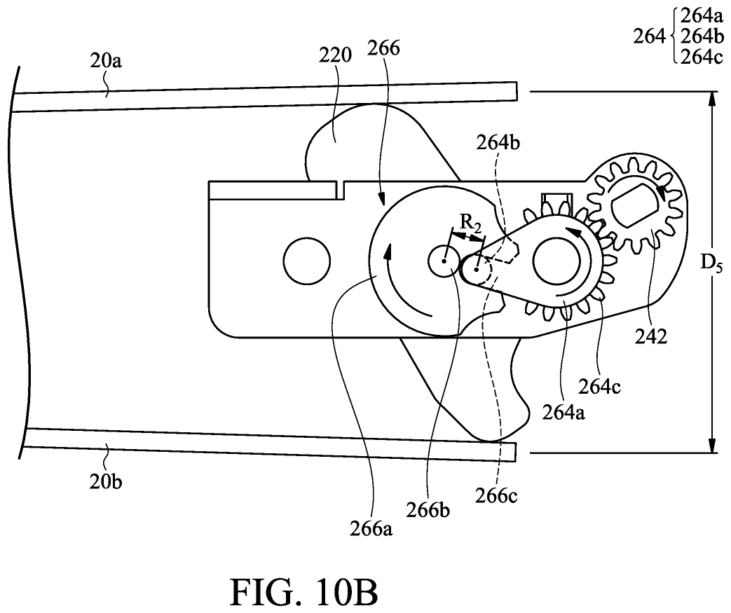

Referring to FIGS. 10A and 10B, FIG. 10A is a perspective view of the pivot structure 200 under other conditions, and FIG. 10B is a schematic view of some components of the pivot structure 200 in FIG. 10A and the upper cover 20a and the lower cover 20b.

Comparing FIG. 10A with FIGS. 9A and 9B: as shown in FIG. 10A, the connecting board 296 rotates clockwise relative to the protruding portion 254 at this time, so the angle θ2 between the connecting board 296 and the protruding portion 254 is greater than the angle θ1 between the connecting board 296 and the protruding portion 254 in FIGS. 9A and 9B. The angle θ2 is approximately the same as the angle between the upper case 10 and the lower case 20.

In FIG. 10B, when the connecting board 296 drives the drive shaft 292 to rotate, the first transmission device 262 on the drive shaft 292 is also rotated, and therefore it drives the middle transmission device 264 to rotate (as shown by the arrow in FIG. 10B). As a result, the column 264b of the middle transmission device 264 moves in the radius direction of the second transmission device 266 in the recess 266c when the middle transmission device 264 is rotating. Meanwhile, the column 264b is getting close to the shaft portion 266b, so the distance R2 between the center of the column 264b and the center of the shaft portion 266b (the second distance) may be smaller than the distance R1 in FIG. 9B.

Furthermore, the lifting mechanism 220 is also driven by the shaft portion 266b to rotate, and therefore it abuts the upper cover 20a and the lower cover 20b to increase the maximum vertical distance between the upper cover 20a and the lower cover 20b to distance D5, which is greater than distance D4 between the upper cover 20a and the lower cover 20b in FIG. 9B. Although the lifting mechanism 220 is illustrated as abutting the upper cover 20a and the lower cover 20b at the same time in FIG. 10B, the present invention is not limited thereto. For example, the position and/or shape of the lifting mechanism 220 or other mechanisms may be altered to make sure that the lifting mechanism 220 only comes into contact with either the upper cover 20a or the lower cover 20b. With this configuration, the upper cover 20a and/or lower cover 20b of the lower case 20 may be opened when opening the upper case 10 of the electronic device 1. As a result, the space for air to come in or for heat dissipation is increased to increase the heat dissipation effect of the electronic device 1.

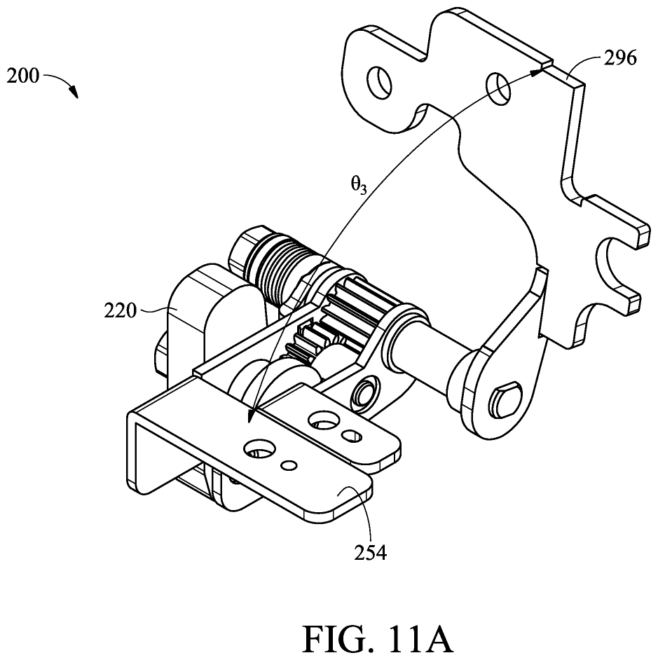

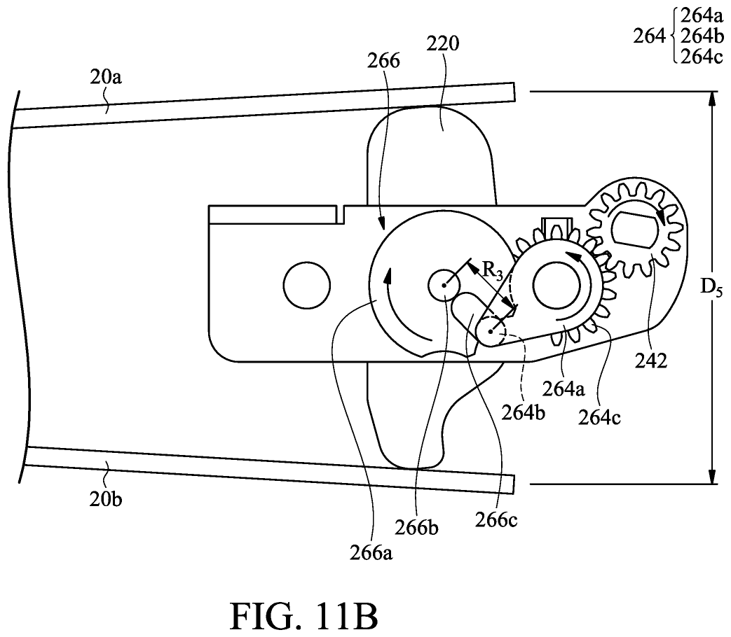

Refer to FIGS. 11A and 11B. FIG. 11A is a perspective view of the pivot structure 200 in one condition, and FIG. 11B is a schematic view of some components of the pivot structure 200 in FIG. 11A and the upper cover 20a and the lower cover 20b.

Comparing FIG. 11A with FIGS. 10A and 10B, the connecting board 296 is rotated further clockwise relative to the protruding portion 254. As a result, as shown in FIG. 11A, an angle θ3 (the threshold angle) between the connecting board 296 and the protruding portion 254 is greater than the angle θ2 between the connecting board 296 and the protruding portion 254 in FIGS. 10A and 10B. The angle θ3 is approximately the same as the angle between the upper case 10 and the lower case 20. Meanwhile, the angle θ3 is a common angle for the use of this kind of folding-type electronic device, which is about 100 degrees, or between about 90 degrees and about 110 degrees.

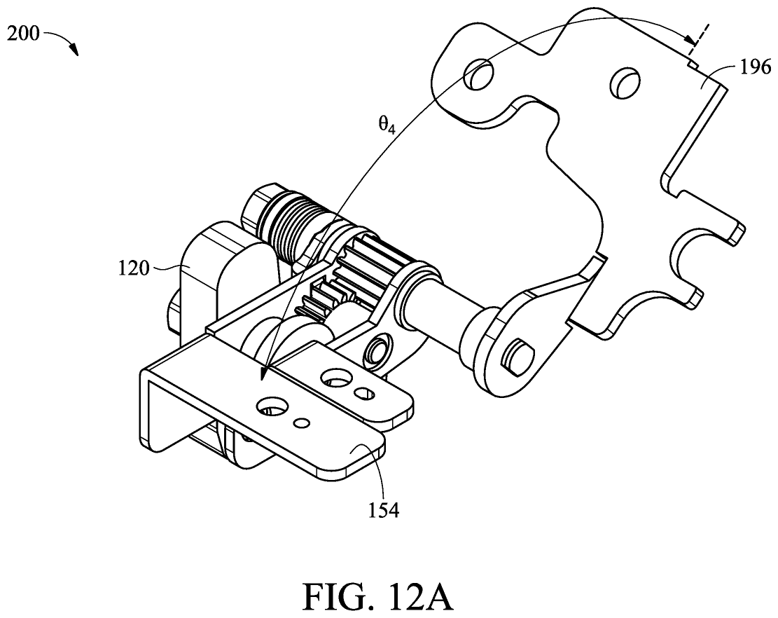

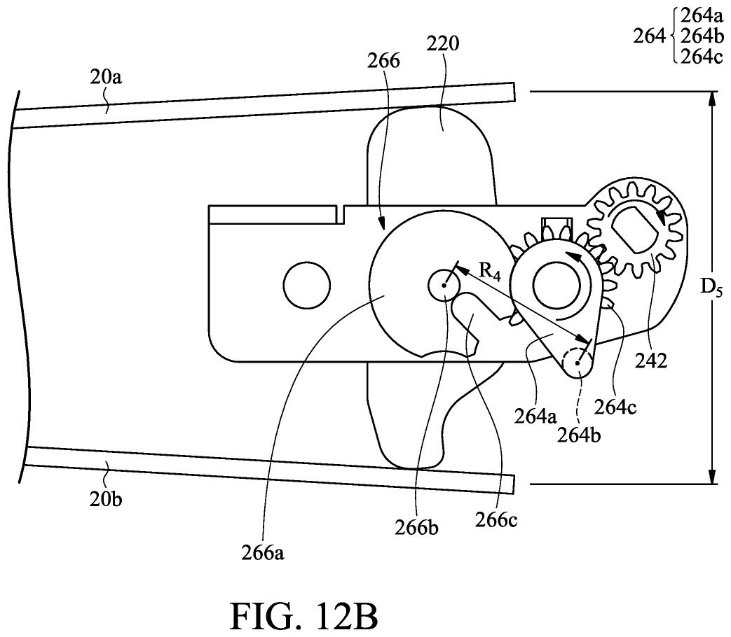

In FIG. 11B, while the connecting board 296 is driving the drive shaft 292 to rotate, the first transmission device 262 and the middle transmission device 264 are also driven to rotate further. As a result, as shown in FIG. 11B, when the middle transmission device 264 is rotating, the column 264b may move in the radius direction of the second transmission device 266 in the recess 266c, but the column 264b may leave the shaft portion 266b to make sure that the distance R3 between the center of the column 264b and the center of the shaft 266b is greater than the distance R2 in FIG. 10B. Under some conditions, the distance R3 is the same as the distance R1 (first distance). It should be noted that, after the angle between the connecting board 296 and the protrusion 254 is greater than the angle θ3 (the threshold angle), the column 264b leaves the recess 266c and does not abut the recess 266c, as shown in FIGS. 12A and 12B described below.

Meanwhile, the lifting mechanism 220 rotates further than the lifting mechanism 220 in FIG. 10B to allow the maximum vertical distance between the upper cover 20a and the lower cover 20b to be increased from distance D5 to distance D6. As a result, the space for air to come in or for heat dissipation is further increased to increase the heat dissipation effect of the electronic device 1.

Referring to FIGS. 12A and 12B, FIG. 12A is a perspective view of the pivot structure 200, and FIG. 12B is a schematic view of some components of the pivot structure 200 and the upper cover 20a and the lower cover 20b.

Meanwhile, compared to FIGS. 11A and 11B, the connecting board 296 in FIG. 12A rotates further clockwise relative to the protruding portion 254, so the angle θ4 (maximum angle) between the connecting board 296 and the protruding portion 254 is greater than the angle θ3 between the connecting board 296 and the protruding portion 254 in FIGS. 11A and 11B. The angle θ4 is approximately the same as the angle between the upper case 10 and the lower case 20 under these conditions. The upper case 10 of the electronic device 1 is opened to the largest degree relative to the lower case 20 after the angle between the protruding portion 254 and the connecting board 296 reaches the angle θ4, which is about 140 degrees (such as 130-150 degrees).

Referring to FIG. 12B, compared to FIG. 11B, the middle transmission device 264 rotates further counterclockwise. As a result, the column 264b is getting farther from the recess 266c, and the distance between the center of the column 264b and the center of the shaft portion 266b is increased from R3 to R4. Furthermore, the column 264b does not contact the recess 266c, so the middle transmission device 264 does not transmit torque to the second transmission device 266. As a result, the second transmission device 266 and the lifting mechanism 220 do not rotate. Compared to FIG. 11B, the distance between the upper cover 20a and the lower cover 20b is still distance D6 rather than being increased. Therefore, the angle between the upper case 10 and the lower case 20 only has to be an angle which is most suitable for a common user (e.g. angle θ3) to reach the best heat dissipation effect for the electronic device 1, instead of being a maximum angle between the upper case 10 and the lower case 20.

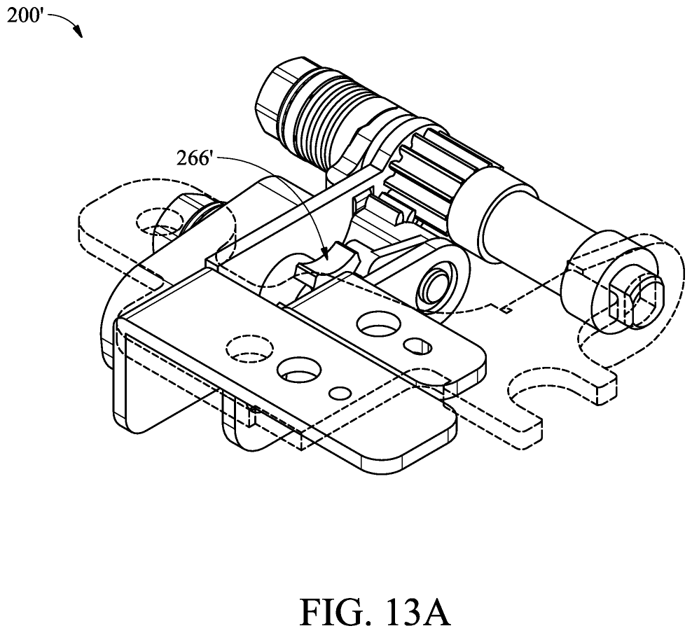

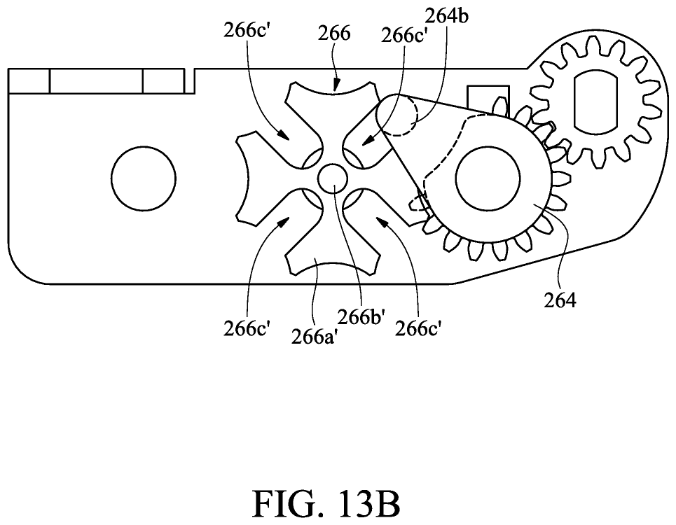

FIGS. 13A and 13B are respectively a perspective view and an exploded view of a pivot structure 200′ in another embodiment of the present invention. The structure of the pivot structure 200′ is substantially the same as that of the pivot structure 200, the difference is that the second transmission device 266 is replaced by a second transmission device 266′. As a result, the details of the repeated components are not repeated herein.

Referring to FIG. 13B, compared to the second transmission device 266, the second transmission device 266′ in this embodiment includes a wheel portion 266a′ and a shaft portion 266b′, and the wheel portion 266a′ has four recesses 266c′. As a result, the second transmission device 266′ has a cruciform structure, the column 264b of the middle transmission device 264 may also be movable in the recess 266c′ of the second transmission device 266′, and providing torque to the second transmission device 266′ in a similar manner as the previous embodiment. Although four recesses 266c′ are illustrated in this embodiment, the present invention is not limited thereto. For example, depending on design requirements, a different number of recesses (e.g. 2, 3, 5, etc.) may be disposed on the second transmission device 266′.

In summary, several pivot structures and electronic devices using the same are provided. The pivot structures allow the distance between the upper and lower covers of the lower case to be increased when the upper case and lower case of the electronic device is opened and closed at a specific range of angles, thereby providing more space for heat dissipation to enhance the heat dissipation effect. Furthermore, the pivot structures also allow the distance between the upper and lower covers of the lower case to remain the same when the angle between the upper case and the lower case of the electronic device is over the threshold angle, thereby reaching the best heat dissipation effect at an angle which is commonly used with this kind of electronic device.

Although embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope of such processes, machines, manufacture, compositions of matter, means, methods, or steps. In addition, each claim constitutes a separate embodiment, and the combination of various claims and embodiments are within the scope of the disclosure.

What is claimed is:

1. A pivot structure, comprising:
a first transmission device;
a middle transmission device meshed with the first transmission device;
a second transmission device meshed with the middle transmission device;
a drive shaft passing through the first transmission device;
a first restriction device disposed on the drive shaft and comprising a first circumferential portion and a second circumferential portion;
a middle restriction device comprising a first recess and an abutting portion, wherein the first recess faces the first restriction device, and the abutting portion is at an opposite side of the first recess; and
a second restriction device abutting the middle restriction device and comprising a second recess and an outer edge portion;
wherein when the first circumferential portion of the first restriction device abuts the first recess of the middle restriction device, the abutting portion of the middle restriction device abuts the outer edge portion of the second restriction device, and when the second circumferential portion of the first restriction device abuts the first recess of the middle restriction device, the abutting portion of the middle restriction device abuts the second recess of the second restriction device.

2. The pivot structure as claimed in claim 1, further comprising:
a connecting board disposed on the drive shaft;
a driven shaft passing through the second restriction device;
a lifting mechanism disposed on the driven shaft; and
a first bracket; wherein the first restriction device, the middle restriction device, and the second restriction device are disposed at a different side of the first bracket with the lifting mechanism.

3. The pivot structure as claimed in claim 2 further comprising a second bracket, wherein the second bracket is passed through by the drive shaft and the driven shaft, the first restriction device and the second restriction device are disposed at one side of the second bracket, and the first transmission device and the second transmission device are disposed at another side of the second bracket.

4. The pivot structure as claimed in claim 3, wherein the drive shaft comprises a first non-rounded shaft part, and the driven shaft comprises a second non-rounded shaft part, wherein the first transmission device comprises a rounded hole, and the second transmission device comprises a non-rounded hole, wherein the first non-rounded shaft portion of the drive shaft passes through the rounded hole, and the second non-rounded shaft portion of the driven shaft passes through the non-rounded hole.

5. The pivot structure as claimed in claim 4, wherein when the second circumferential portion of the first restriction device abuts the first recess of the middle restriction device, the first non-rounded shaft portion of the drive shaft is rotatable with respect to the rounded hole of the first transmission device, and the second non-rounded shaft portion of the driven shaft is engaged with the non-rounded hole of the second transmission device.

6. The pivot structure as claimed in claim 1, wherein the radius of the first circumferential portion of the first restriction device is smaller than that of the second circumferential portion.

7. A pivot structure, comprising:
a first transmission device;
a second transmission device meshed with the first transmission device and comprising a column;
a second transmission device detachably connected to the middle transmission device and comprising a recess; and
a driven shaft passing through the second transmission device and being rotated by the rotation of the second transmission device;
wherein the column is disposed in the recess and the second transmission device is rotated by rotation of the middle transmission device when a distance between a center of the column and a center of the driven shaft is less than a first distance.

8. The pivot structure as claimed in claim 7, further comprising:
a drive shaft passing the first transmission device;
a lifting mechanism device disposed on the driven shaft; and
a bracket passed through by the drive shaft and the driven shaft, wherein the lifting mechanism is disposed at one side of the bracket, and the first transmission device, the middle transmission device and the second transmission device are disposed at another side of the bracket.

9. The pivot structure as claimed in claim 7, wherein the second transmission device further comprises a plurality of recesses.

10. An electronic device, comprising:
a lower case;
a pivot structure according to claim 1 connected to the lower case; and
an upper case connected to the pivot structure to rotate between a maximum angle and a minimum angle with respect to the lower case.
